(19) United States
(12) Patent Application Publication
(10) Pub. No.: US 2025/0368060 A1
(43) Pub. Date: Dec. 4, 2025

(54) FAST MULTI-CHARGE ASSIST ON-BOARD CHARGER AND METHOD

(71) Applicants: Hyundai Motor Company, Seoul (KR); Kia Corporation, Seoul (KR)

(72) Inventors: Jinsu Hong, Hwaseong-si (KR); Hui-sung Jang, Hwaseong-si (KR); Yong Jae Lee, Hwaseong-si (KR); YooJong Lee, Hwaseong-si (KR); Hotae Chun, Hwaseong-si (KR); DongGyun Woo, Hwaseong-si (KR)

(21) Appl. No.: 18/960,504

(22) Filed: Nov. 26, 2024

(30) Foreign Application Priority Data
May 31, 2024 (KR) 10-2024-0071669

(51) Int. Cl. B60L 53/10; B60L 53/16

(52) U.S. Cl. CPC B60L 53/11; B60L 53/16

(57) ABSTRACT

An embodiment fast multi-charge assist on-board charger includes a main multi-charge circuit connecting a charger to a battery, a charge controller connected to the battery, a fast charge line connecting the charger to the main multi-charge circuit, a switch disposed on the fast charge line, a first slow charge line connecting the charger to the fast charge line, and a second slow charge line connecting the fast charge line to the charge controller.

### CROSS-REFERENCE TO RELATED APPLICATIONS

This application claims the benefit of Korean Patent Application No. 10-2024-0071669, filed on May 31, 2024, which application is hereby incorporated herein by reference.

### TECHNICAL FIELD

The disclosure relates to a fast multi-charge assist on-board charger and method.

### BACKGROUND

800V class vehicles adopt multi-charging technology (boosting using a motor system) to use the existing 400V class fast charge infrastructure. Multi-charging technology is a method of charging through a power conversion device in a vehicle when direct charging of a battery is not available due to electric vehicle supply equipment (EVSE) output voltage limitations.

With the introduction of the North American charging standard (NACS), demand for improved charging speed during multi-charging using Tesla's V3 supercharger (400V class) has increased.

In the case of Tesla's supercharger, the charger is designed with a high output current (500 A) to shorten charging time, but the charging time is inferior during multi-charging due to a rating limit (300 A) of the power conversion device in the vehicle.

### SUMMARY

The disclosure relates to a fast multi-charge assist on-board charger and method. Particular embodiments relate to a fast multi-charge assist on-board charger and method that assist fast multi-charging using a charge controller.

Embodiments of the present disclosure provide a fast multi-charge assist on-board charger and method capable of assisting fast multi-charging using a charge controller.

Embodiments of the present disclosure also provide a fast multi-charge assist on-board charger and method for connecting a fast charge line to a slow charge line so that a fast charge input may be connected to a slow charge input to improve multi-charging capacity.

According to exemplary embodiments, a fast multi-charge assist on-board charger includes a main multi-charge circuit connecting a charger to a battery, a charge controller connected to the battery, a fast charge line connecting the charger to the main multi-charge circuit, a switch disposed on the fast charge line, a first slow charge line connecting the charger to the fast charge line, and a second slow charge line connecting the fast charge line to the charge controller.

The charger may include a combined charging standard (CCS) method, a CHAdeMO method, and a GB/T method.

The charge controller may include an on-board charger.

The first slow charge line may be connected to a first portion of the fast charge line, the second slow charge line may be connected to a second portion of the fast charge line, and the first portion may be closer to the charger than the second portion.

The first slow charge line and the second slow charge line may operate the charge controller by branching a charge input of the fast charge line.

When the charger is connected to a vehicle, the main multi-charge circuit and the charge controller may operate simultaneously to charge the battery.

According to exemplary embodiments, a fast multi-charge assist on-board charger includes a main multi-charge circuit connecting a charger to a battery, a charge controller connected to the battery, a fast charge line connecting the charger and the main multi-charge circuit, a first switch disposed on the fast charge line, a slow charge line connecting the charger to the charge controller, a connection line connecting the fast charge line to the slow charge line, and a second switch disposed on the connection line.

The charger may include a combined charging standard (CCS) method, a CHAdeMO method, and a GB/T method.

The connection line may branch a charge input introduced from the charger into the fast charge line to the slow charge line.

The main multi-charge circuit and the charge controller may operate together to fast charge the battery.

According to exemplary embodiments, a fast multi-charge assisting method includes identifying a fast charger, measuring an output voltage of the fast charger through a charge controller, when the output voltage is within an allowable voltage range, connecting the fast charger to the main multi-charge circuit through a switch disposed on a fast charge line, connecting the fast charger to a charge controller through a slow charge line, and charging the battery by simultaneously driving the main multi-charge circuit and the charge controller.

The fast charger may include a North American charging standard (NACS) method, a combined charging standard (CCS) method, a CHAdeMO method, and a GB/T method.

The charge controller may include an on-board charger.

The slow charge line may include a first slow charge line connecting the fast charger to the fast charge line and a second slow charge line connecting the fast charge line to the charge controller.

The first slow charge line may be connected to a first portion of the fast charge line, the second slow charge line may be connected to a second portion of the fast charge line, and the first portion may be closer to the charger than the second portion.

The slow charge line may be connected to the fast charge line.

The connecting of the fast charger to the charge controller through the slow charge line may further include operating the charge controller by branching a charge input of the fast charge line through the slow charge line.

The connecting of the fast charger to the charge controller through the slow charge line may further include connecting the slow charge line to the fast charge line through a connection line.

The connecting of the fast charger to the charge controller through the slow charge line may further include operating the charge controller by branching a charge input of the fast charge line through the connection line.

The fast multi-charge assisting method may further include performing power factor correction (PFC).

In the fast multi-charge assist on-board charger and method according to an embodiment of the disclosure, the fast charge line is connected to the slow charge line so that a fast charge input may be connected to a slow charge input, and the charge controller assists fast multi-charging, thereby improving multi-charging capacity and multi-charging efficiency.

### BRIEF DESCRIPTION OF THE DRAWINGS

FIG. 1 is a diagram illustrating a fast multi-charge assist on-board charger according to an embodiment of the disclosure.

FIG. 2 is a diagram illustrating a fast multi-charge assist on-board charger according to an embodiment of the disclosure.

FIG. 3 is a diagram illustrating a fast multi-charge assist on-board charger according to an embodiment of the disclosure.

FIG. 4 is a flowchart illustrating a fast multi-charge assisting method according to an embodiment of the disclosure.

FIG. 5 is a flowchart illustrating a fast multi-charge assisting method according to an embodiment of the disclosure.

### DETAILED DESCRIPTION OF ILLUSTRATIVE EMBODIMENTS

Hereinafter, embodiments will be described in detail with reference to the accompanying tables and drawings such that they may be easily practiced by those skilled in the art to which the disclosure pertains. However, the disclosure may be modified in various different ways and is not limited to the exemplary embodiments set forth herein. Portions that are irrelevant to the description will be omitted to clearly describe the disclosure, and same reference numerals designate same or like elements throughout the description.

Throughout the specification and claims, unless explicitly described to the contrary, the word “comprise,” and variations, such as “comprises” or “comprising,” will be understood to imply the inclusion of stated elements but not the exclusion of any other elements. It will be understood that, although the terms first, second, etc. may be used herein to describe various elements, these elements should not be limited by these terms. These terms are only used to distinguish one element from another.

The terms “part,” “unit,” and “module” described in the specification refer to a unit capable of processing at least one function or operation described in this specification and may be implemented by hardware or circuits, software, or a combination of hardware or circuits and software. In the specification, the meaning of “connection” may include both physical connection and electrical connection.

Hereinafter, embodiments of the disclosure will be described with reference to the drawings.

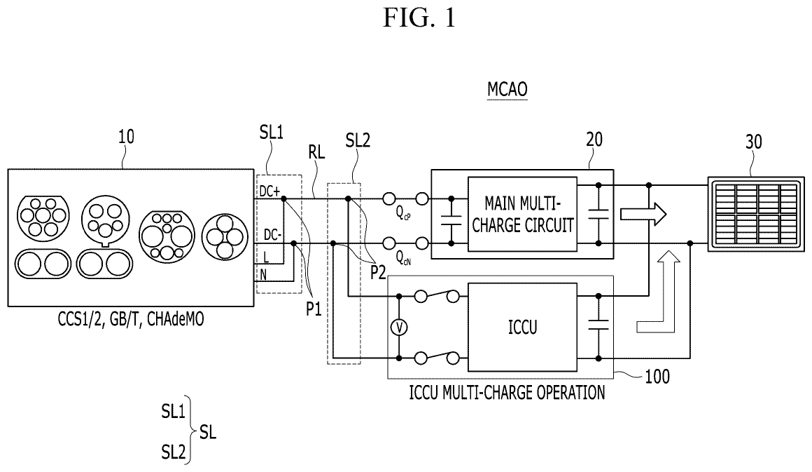

FIG. 1 is a diagram illustrating a fast multi-charge assist on-board charger (MCAO) according to an embodiment of the disclosure.

The fast MCAO may assist the existing multi-fast charge system by simultaneously driving an on-board charger (OBC) of an integrated charge controller (ICCU) with multi-charging.

Referring to FIG. 1, the MCAO includes a main multi-charge circuit 20, a charge controller 100, a fast charge line RL, and a slow charge line SL.

The main multi-charge circuit 20 connects a charger 10 to a battery 30. The main multi-charge circuit 20 may charge the battery using an 800V high-voltage charger and a 400V fast charger in a multi-charging method including a voltage-boosting or voltage-reducing method.

The multi-charging method may refer to charging through a power conversion device within a vehicle when direct charging of the battery is not possible due to limitations of an electric vehicle supply equipment (EVSE) output voltage.

The charger 10 may include a fast charger. The fast charger may include a 150V to 400V fast charge station. The fast charger may include the combined charging standard (CCS) method, the CHAdeMO method, and the GB/T method. The CCS method includes both CCS1/CCS2 methods.

The battery 30 may include an 800V high voltage battery.

The charge controller 100 may be connected to the battery 30.

The charge controller 100 may include an integrated charge controller (ICCU). The charge controller 100 may include an on-board charger (OBC) within the ICCU.

The fast charge line RL may connect the charger 10 to the main multi-charge circuit 20. Switches Q_{cP} and Q_{cN} may be disposed on the fast charge line RL. The switch may be a relay switch.

The slow charge line SL includes a first slow charge line SL1 and a second slow charge line SL2. The slow charge line SL may operate the charge controller 100 by branching a charge input introduced from the fast charger 10 to the fast charge line RL.

The first slow charge line SL1 may connect the charger 10 to the fast charge line RL. The second slow charge line SL2 may connect the fast charge line RL to the charge controller 100.

The first slow charge line SL1 may be connected to the first portion P1 of the fast charge line RL, and the second slow charge line SL2 may be connected to the second portion P2 of the fast charge line RL. The first portion P1 may be defined to be closer to the charger 10 than the second portion P2.

That is, the first slow charge line SL1 and the second slow charge line SL2 may operate the charge controller 100 by branching the charge input of the fast charge line RL.

The MCAO according to the embodiment of FIG. 1 may include the first slow charge line SL1 and the second slow charge line SL2 and charge the battery 30 by simultaneously driving the charge controller 100 together with the main multi-charge circuit 20.

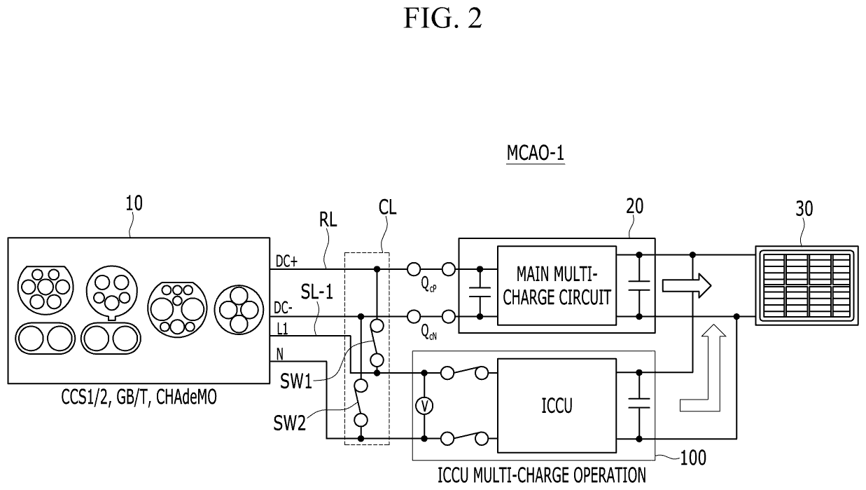

FIG. 2 is a diagram illustrating a fast multi-charge assist on-board charger (MCAO-1) according to an embodiment of the disclosure.

Referring to FIG. 2, the fast MCAO-1 may include a main multi-charge circuit 20, a charge controller 100, a fast charge line RL, a slow charge line SL-1, and a connection line CL.

The main multi-charge circuit 20 connects the charger 10 to the battery 30. The main multi-charge circuit 20 may charge the battery using both an 800V-class charger and a 400V-class charger infrastructure through a multi-charging system using a motor system within a vehicle.

The charger 10 may include a fast charger. The fast charger may include a 150V to 400V fast charge station. The fast charger may include the CCS method, the CHAdeMO method, and the GB/T method.

The battery 30 may include a high voltage battery. The high voltage battery may be an 800V battery.

The charge controller 100 may be connected to the battery 30. The charge controller 100 may include an ICCU. The charge controller 100 may include an on-board charger (OBC) within the ICCU.

The fast charge line RL may connect the charger 10 to the main multi-charge circuit 20. First switches Q_{cP} and Q_{cN} may be disposed on the fast charge line RL.

The slow charge line SL-1 may connect the charger 10 to the charge controller 100.

The connection line CL may connect the fast charge line RL to the slow charge line SL-1. Second switches SW1 and SW2 may be disposed on the connection line CL. The first switches Q_{cP} and Q_{cN} and the second switches SW1 and SW2 may be relay switches.

The connection line CL may branch a charge input introduced from the charger 10 to the fast charge line RL to the slow charge line SL-1 and drive the charge controller 100.

The fast MCAO-1 according to the embodiment of FIG. 2 may include the connection line CL and may charge the battery 30 by simultaneously driving the charge controller 100 together with the main multi-charge circuit 20.

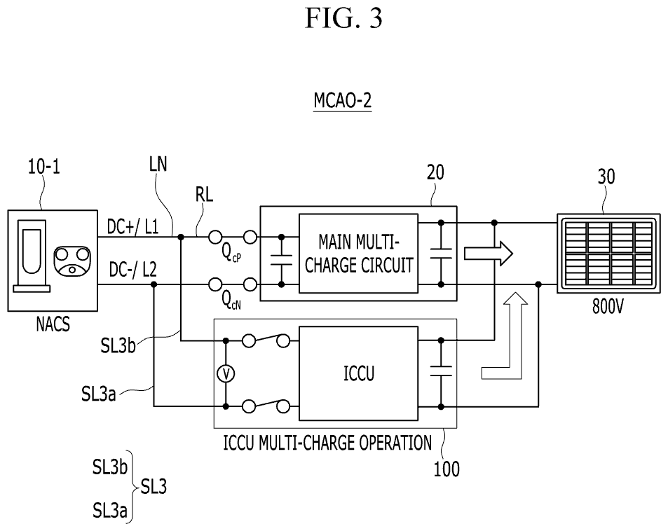

FIG. 3 is a diagram illustrating a fast MCAO-2 according to an embodiment of the disclosure.

Referring to FIG. 3, the fast MCAO-2 includes a main multi-charge circuit 20, a charge controller 100, a fast charge line RL, and a slow charge line SL3.

For a description of the main multi-charge circuit 20 and the charge controller 100, the descriptions of FIGS. 1 and 2 are referred to.

In FIG. 3, a charger 10-1 may include a North American charging standard (NACS) method. For example, the charger 10-1 may include all NACS-type charging station infrastructure, including Tesla's supercharger.

In FIG. 3, the fast charge line RL and the slow charge line SL3 are separated from one line LN from the NACS-type charger 10-1.

The slow charge lines SL3a and SL3b may each be connected to the fast charge line RL and branch the charge input introduced to the fast charge line RL to the charge controller 100.

The fast MCAO-2 of FIG. 3 may branch the charge input introduced from the NACS-type charger 10-1 to the fast charge line RL to the slow charge line SL3 to drive the main multi-charge circuit 20 and the charge controller 100 together to fast charge the battery.

In other words, in the fast MCAO-2, the fast charge line and the slow charge line may be commonly used in a charger, such as the NACS-type charger.

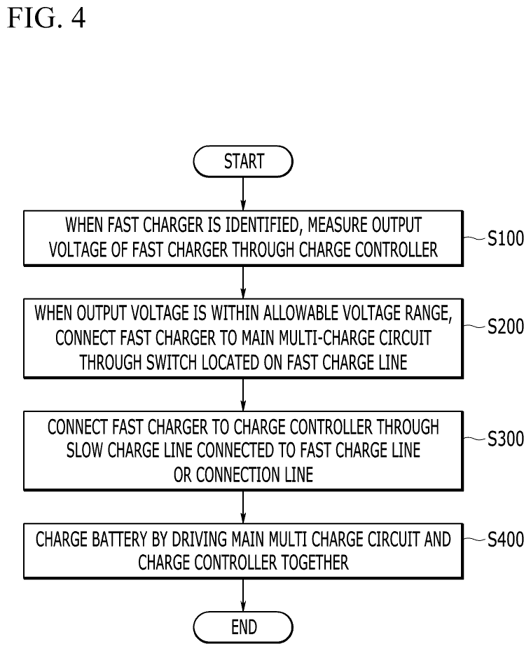

FIG. 4 is a flowchart illustrating a fast multi-charge assisting method according to an embodiment of the disclosure. The fast multi-charge assisting method of FIG. 4 may be performed through any one of the fast MCAO, MCAO-1, and MCAO-2 according to the embodiments of FIGS. 1 to 3.

In FIG. 4, the fast MCAO, MCAO-1, or MCAO-2 may measure an output voltage of the fast charger through the charge controller when the fast charger is identified (operation S100).

If the output voltage is within an allowable voltage range, the fast MCAO, MCAO-1, or MCAO-2 may connect the fast charger to the main multi-charge circuit through a switch located on the fast charge line (operation S200).

The fast MCAO, MCAO-1, or MCAO-2 may connect the fast charger to the charge controller through a slow charge line or a connection line connected to the fast charge line (operation S300).

The slow charge line may include a first slow charge line connecting the fast charger to the fast charge line and a second slow charge line connecting the fast charge line to the charge controller.

The slow charge line may be connected to the fast charge line.

The fast MCAO, MCAO-1, or MCAO-2 may operate the charge controller by branching the charge input of the fast charge line through the slow charge line. The connection line may connect the slow charge line to the fast charge line.

The fast MCAO, MCAO-1, or MCAO-2 may connect the slow charge line to the fast charge line through a connection line.

The fast MCAO, MCAO-1, or MCAO-2 may operate the charge controller by branching the charge input of the fast charge line through the connection line.

The fast MCAO, MCAO-1, or MCAO-2 may charge the battery by driving the main multi-charge circuit and the charge controller together (operation S400).

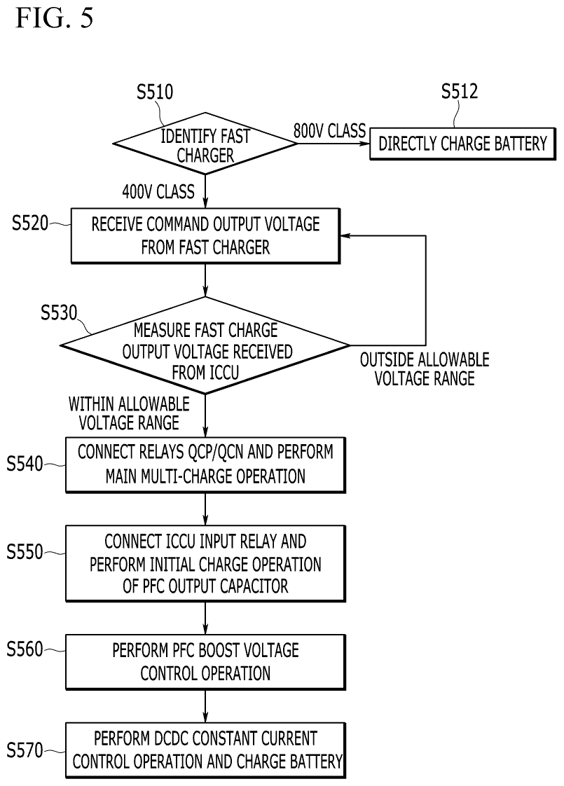

FIG. 5 is a flowchart illustrating a fast multi-charge assisting method according to an embodiment of the disclosure. The fast multi-charge assisting method of FIG. 5 may be performed through any one of the fast MCAO, MCAO-1, and MCAO-2 according to the embodiments of FIGS. 1 to 3.

In FIG. 5, the fast MCAO, MCAO-1, or MCAO-2 may identify the fast charger (operation S510). The fast charger may include the NACS method, the CCS method, the CHAdeMO method, or the GB/T method.

The fast MCAO, MCAO-1, or MCAO-2 may directly charge the battery when the fast charger is identified as 800V class (operation S512).

When the fast charger is identified as 400V class, the fast MCAO, MCAO-1, or MCAO-2 may receive a command output voltage from the fast charger (operation S520).

The fast MCAO, MCAO-1, or MCAO-2 may measure a fast charge output voltage transmitted through the ICCU of the charge controller 100 (see FIGS. 1 to 3) (operation S530).

In the fast MCAO, MCAO-1, or MCAO-2, when the output voltage is within the preset allowable voltage range, the fast charger may be connected to the main multi-charge circuit through the relay switches Q_{cP} and Q_{cN} (see FIGS. 1 to 3) located on the fast charge line and multi-charging may be operated through the main multi-charge circuit (operation S540).

The fast MCAO, MCAO-1, or MCAO-2 may connect the ICCU of the charge controller to the fast charger and perform an initial charging operation of a power factor correction (PFC) output capacitor (operation S550). The charge controller may include an OBC.

The fast MCAO, MCAO-1, or MCAO-2 may perform a PFC boost voltage control operation (operation S560).

The fast MCAO, MCAO-1, or MCAO-2 may operate under DC-DC constant current control and may charge the battery using the charge controller together with the main multi-charge circuit (operation S570).

FIG. 5 shows a method of charging a battery through voltage boosting when using a 400V fast charger.

Even when a vehicle voltage is low compared to a fast charger voltage and the battery is charged through voltage reduction, the fast multi-charge assisting method of FIG. 5 may be applied.

In the case of voltage reduction, operations S520 to S570 may be applied in the same manner. However, the fast MCAO, MCAO-1, or MCAO-2 may perform a voltage reduction operation through operation S520 when an 800V-class fast charger is identified in operation S510 and may perform a direct charging operation through operation S512 when a 400V-class fast charger is identified.

While embodiments of the disclosure have been described in connection with exemplary embodiments, it is to be understood that the embodiments of the invention are not limited to the disclosed exemplary embodiments, but, on the contrary, are intended to cover various modifications and equivalent arrangements included within the spirit and scope of the appended claims.

What is claimed is:

1. A fast multi-charge assist on-board charger comprising:
a main multi-charge circuit connecting a charger to a battery;
a charge controller connected to the battery;
a fast charge line connecting the charger to the main multi-charge circuit;
a switch disposed on the fast charge line;
a first slow charge line connecting the charger to the fast charge line; and
a second slow charge line connecting the fast charge line to the charge controller.

2. The fast multi-charge assist on-board charger of claim 1, wherein the charger is capable of performing a combined charging standard (CCS) method, a CHAdeMO method, and a GB/T method.

3. The fast multi-charge assist on-board charger of claim 1, wherein the charge controller comprises an on-board charger.

4. The fast multi-charge assist on-board charger of claim 1, wherein:
the first slow charge line is connected to a first portion of the fast charge line;
the second slow charge line is connected to a second portion of the fast charge line; and
the first portion is closer to the charger than the second portion.

5. The fast multi-charge assist on-board charger of claim 1, wherein the first slow charge line and the second slow charge line are configured to operate the charge controller by branching a charge input of the fast charge line.

6. The fast multi-charge assist on-board charger of claim 5, wherein, in a state in which the charger is connected to a vehicle, the main multi-charge circuit and the charge controller are configured to operate simultaneously to charge the battery.

7. A fast multi-charge assist on-board charger comprising:
a main multi-charge circuit connecting a charger to a battery;
a charge controller connected to the battery;
a fast charge line connecting the charger and the main multi-charge circuit;
a first switch disposed on the fast charge line;
a slow charge line connecting the charger to the charge controller;
a connection line connecting the fast charge line to the slow charge line; and
a second switch disposed on the connection line.

8. The fast multi-charge assist on-board charger of claim 7, wherein the charger is capable of performing a combined charging standard (CCS) method, a CHAdeMO method, and a GB/T method.

9. The fast multi-charge assist on-board charger of claim 7, wherein the connection line branches a charge input introduced from the charger into the fast charge line to the slow charge line.

10. The fast multi-charge assist on-board charger of claim 7, wherein the main multi-charge circuit and the charge controller are configured to operate together to fast charge the battery.

11. A fast multi-charge assisting method comprising:
identifying a fast charger;
measuring an output voltage of the fast charger through a charge controller;
in response to the output voltage being within an allowable voltage range, connecting the fast charger to a main multi-charge circuit through a switch disposed on a fast charge line;
connecting the fast charger to the charge controller through a slow charge line; and
charging a battery by simultaneously driving the main multi-charge circuit and the charge controller.

12. The fast multi-charge assisting method of claim 11, wherein the fast charger is capable of performing a North American charging standard (NACS) method, a combined charging standard (CCS) method, a CHAdeMO method, and a GB/T method.

13. The fast multi-charge assisting method of claim 11, wherein the charge controller comprises an on-board charger.

14. The fast multi-charge assisting method of claim 11, wherein the slow charge line comprises:
a first slow charge line connecting the fast charger to the fast charge line; and
a second slow charge line connecting the fast charge line to the charge controller.

15. The fast multi-charge assisting method of claim 14, wherein:
the first slow charge line is connected to a first portion of the fast charge line;
the second slow charge line is connected to a second portion of the fast charge line; and
the first portion is closer to the charger than the second portion.

16. The fast multi-charge assisting method of claim 11, wherein the slow charge line is connected to the fast charge line.

17. The fast multi-charge assisting method of claim 16, wherein connecting the fast charger to the charge controller through the slow charge line further comprises operating the charge controller by branching a charge input of the fast charge line through the slow charge line.

18. The fast multi-charge assisting method of claim 11, wherein connecting the fast charger to the charge controller through the slow charge line further comprises connecting the slow charge line to the fast charge line through a connection line.

19. The fast multi-charge assisting method of claim 18, wherein connecting the fast charger to the charge controller through the slow charge line further comprises operating the charge controller by branching a charge input of the fast charge line through the connection line.

20. The fast multi-charge assisting method of claim 11, further comprising performing power factor correction.
